(19) United States
(12) Patent Application Publication
(10) Pub. No.: US 2019/0059564 A1
(43) Pub. Date: Feb. 28, 2019

(54) FIREFIGHTER RESCUE DEVICE

(71) Applicant: Sanford Keith Hughes, Ocala, FL (US)

(72) Inventor: Sanford Keith Hughes, Ocala, FL (US)

(21) Appl. No.: 15/687,711

(22) Filed: Aug. 28, 2017

(51) Int. Cl. A45F 3/14; A45F 3/04; A62B 25/00; A45F 3/10

(52) U.S. Cl. CPC A45F 3/14; A45F 3/047; A45F 2003/045; A45F 3/10; A45F 2003/146; A62B 25/00

(57) ABSTRACT

A safety assembly is provided to be worn by firefighters or other emergency personnel employing air tanks. The safety assembly provides a back pack having a top handle disposed along an upper portion thereof. The back pack is connected to a belt and arm straps to secure around the wearer. Two spaced apart leg straps depend from the belt and converge at an attachment point. A connector depends from the attachment point, wherein the connector is adapted to engage the belt in a locked configuration. A bottom handle depends from the connector. When the wearer is in need of rescue, a rescuer may utilize the top or bottom handle of the safety assembly to drag the wearer to safety, while the leg straps secures the safety assembly through the rescue process.

### BACKGROUND OF THE INVENTION

The present invention relates to firefighter rescue devices and, more particularly, to a life saving device for rescuing firefighters.

During fire-related rescues, time is a matter of life or death. Current devices used by firefighters to rescue injured or trapped comrades may work, but has a very low success rate for life safety. The major reason is that current devices do not have a built-in assembly that enables dragging of firefighter without the risk of separating the firefighter and their assembly and/or air tank.

As can be seen, there is a need for a firefighter rescue device that saves vital time rescuing injured or trapped firefighters, wherein the firefighter rescue device can be built into the current system, making it easier to rescue a victim in less than half the time it currently takes. The novel firefighter rescue device embodies a method of rescuing downed firefighters by eliminating several steps which take up valuable time.

The present invention is a ready-made safety assembly that can be built into the current device already used, always ready to save a victim.

### SUMMARY OF THE INVENTION

In one aspect of the present invention, a safety assembly includes a back pack extending from an upper portion to a lower portion; a top handle provided by the upper portion; a belt extending from the lower portion in opposite directions; a female connector provided by each distal end of the belt; two spaced apart leg straps depending from opposing portions of the belt, wherein the two leg straps connect at an attachment point; and a male connector depending from the attachment point, wherein the male connector is adapted to removably secure to said female connectors in a locked engagement.

In another aspect of the present invention, the safety assembly includes a back pack extending from an upper portion to a lower portion; a top handle provided by the upper portion, wherein the top handle is located adjacent a back neck of a wearer when the safety assembly is worn; a belt extending from the lower portion in opposite directions; a female connector provided by each distal end of the belt; two spaced apart leg straps depending from opposing portions of the belt, wherein the two leg straps connect at an attachment point; a male connector depending from the attachment point, wherein the male connector is adapted to removably secure to said female connectors in a locked engagement; a bottom handle depending from the male connector, wherein the bottom handle is oriented in an upward orientation when the safety assembly is worn; and a GPS locator connected to the safety assembly.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention;

FIG. 3 is a front flat view of an exemplary embodiment of the present invention; and

FIG. 4 is a back right view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a safety assembly to be worn by firefighters or other emergency personnel employing air tanks. The safety assembly provides a back pack having a top handle disposed along an upper portion thereof. The back pack is connected to a belt and arm straps to secure around the wearer. Two spaced apart leg straps depend from the belt and converge at an attachment point. A connector depends from the attachment point, wherein the connector is adapted to engage the belt in a locked configuration. A bottom handle depends from the connector. When the wearer is in need of rescue, a rescuer may utilize the top or bottom handle of the safety assembly to drag the wearer to safety, while the leg straps secures the safety assembly through the rescue process.

It should be understood by those skilled in the art that the use of directional terms such as upper, lower, upward, downward, top, bottom, outward, inward and the like are used in relation to the illustrative embodiments as they are depicted in the figures, the upward direction (or upper) being toward the top of the corresponding figures and a downward direction being toward the bottom of the corresponding figure.

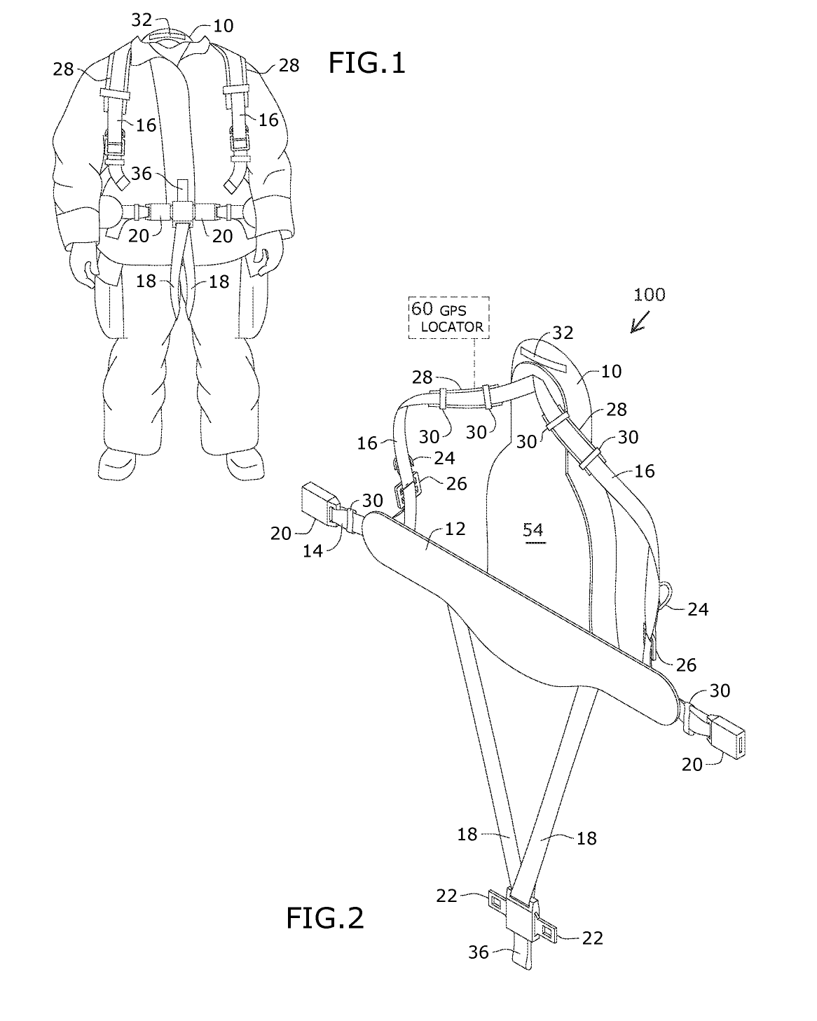

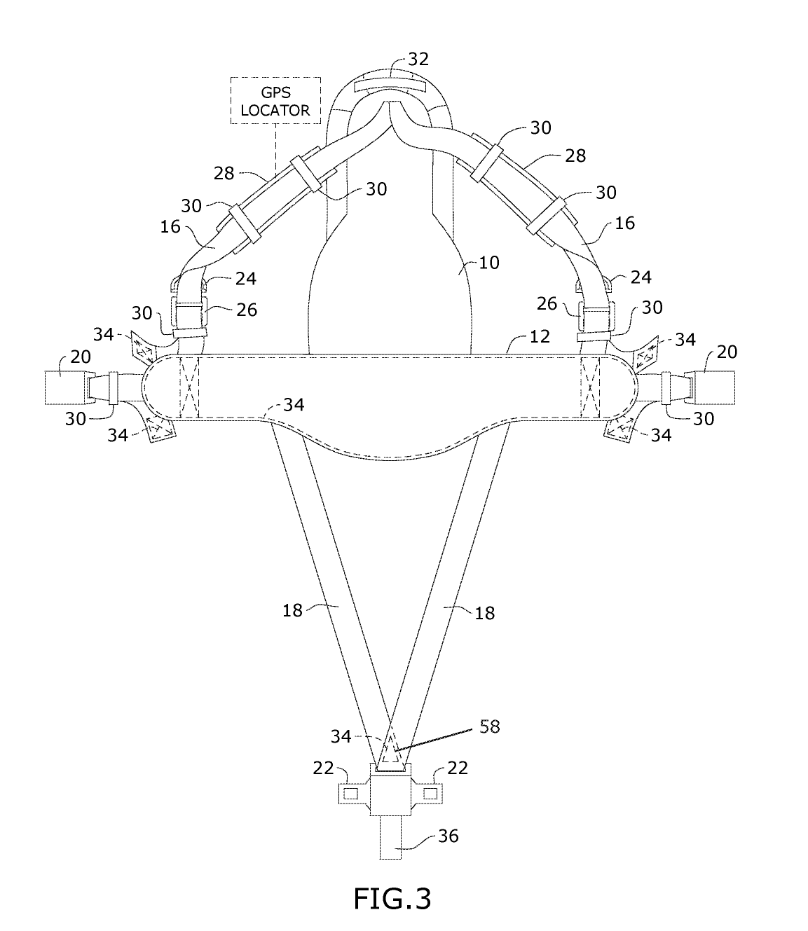

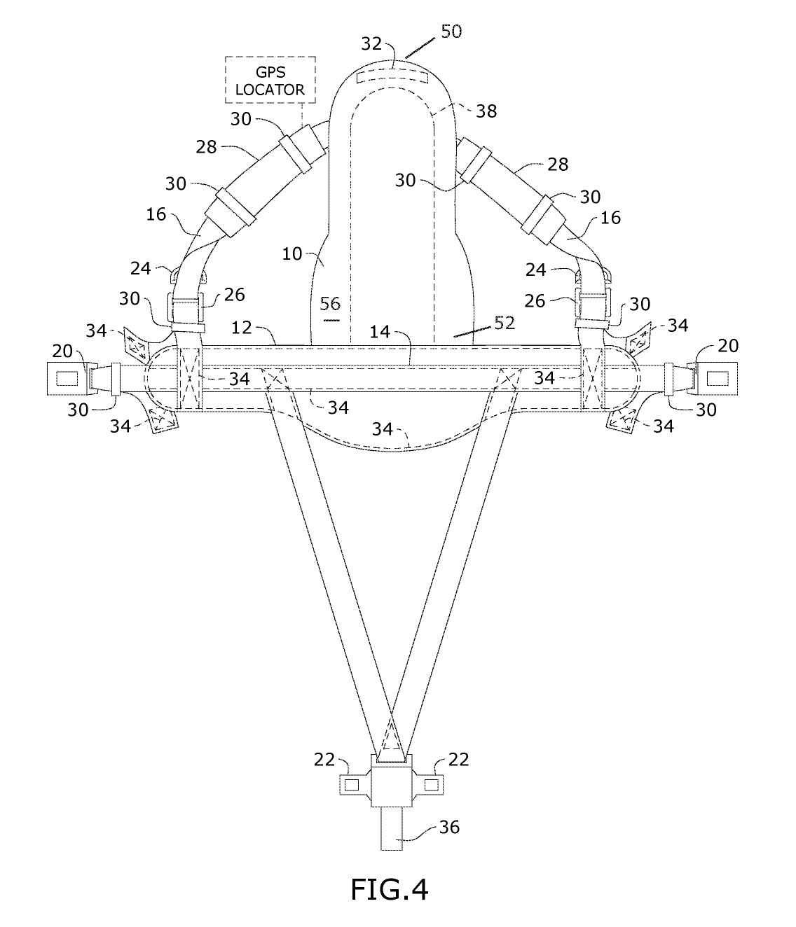

Referring to FIGS. 1 through 4, the present invention may include a safety assembly 100 having a back pack 10 extending from an upper portion 50 to a lower portion 52, wherein the upper portion 50 may be adapted to be located adjacent a wearer's neck when said safety assembly 100 is worn. Similarly, when the safety assembly 100 is worn, the lower portion 52 may be adapted to be located adjacent the waist of the wearer. The back pack 10 may be generally elongated wherein the upper portion 50 resembles a ‘head’ to the lower portion's 52 ‘torso’, as illustrated in FIG. 2. The back pack 10 has an outward (facing) surface 56 and an inward (facing) surface 54. Along the outward surface 56 an air tank area 38 may be provided to accommodate an air tank of the wearer, such as firefighters or other emergency personnel. It should be understood that the safety assembly 100 can be devised without the air tank and still be used by LEO (Law Enforcement Officers) and for military applications as well.

A top handle 32 may be provided by the upper portion 50 so that it communicates the outward and inward surfaces 56 and 54. In another embodiment, the top handle 32 may attached to the top of the air pack with bolts or is welded in place.

Extending in opposite directions from the lower portion may be a belt 12 adapted to wrap around the waist of the wearer. Female connectors 20 may be disposed at the opposing distal ends of the belt 12, as illustrated in FIG. 2. Interconnected each distal end and female connector 20 may be a belt strap 14 having a band 30 for adjusting the snug fit of the belt 12 along the waist of the wearer. Two arms straps 16 extend in opposite directions from the inward surface 54 of the lower portion 52 to their respective distal ends of said belt 14. When worn, the two arm straps 16 may be adapted to extend from adjacent an upper back of a wearer to over their shoulder and down the front of the wearer connecting to the belt 14, as illustrated in FIG. 1. Along both of the two arm straps 16 may be a slide 26 and at least one D-ring 24 adapted to adjust the length and/or snugness of the arm strap 16 about the wearer. Strap pads 28 may also be provided along the arm straps 16.

At least one of the two arm straps 16 may provide a GPS locator 60. The GPS locator 60 may be disposed in the arm/shoulder straps of a current system and/or be secured inside the arm/shoulder strap 16 of the safety assembly 100 with a removable fastener. The GPS locator 60 is a vital part of saving the lives of firefighters. Currently, trapped firefighters only rely on their radio transmissions to let the rescue team know where they are. If they are incapacitated for any reason and either cannot tell the rescue team where they are or they are lost/confused and don't know where they are. The GPS locator 60 will be in direct communication with the IC's (Incident Commander) equipment thereby giving him or her an exact location of the downed firefighter, saving valuable time locating and removing said firefighter from danger.

Spaced apart leg straps 18 may depend from opposing portions of the belt 14 so that they meet at an attachment point 58 below the approximate midpoint of the belt 14. The attachment point 58 may be secured with stitching 34 or other joining elements. A two-faced male connector 22 may depend from the attachment point 34 so that each of the two faces can removably secure to one of the two female connectors 20 in a locked configuration, as illustrated in FIG. 1, yet be movable between the locked and an unlocked configuration. The connectors 20 and 22 may be buckles or other removably attaching devices. Depending from the two-faced male connector 22 may be a bottom handle 36. The bottom handle 36 may be strap or the like. The bottom handle may be adapted to be oriented in an upward orientation when the safety assembly 10 is worn, as illustrated in FIG. 1.

A method of using the present invention may include the following. The safety assembly 100 disclosed above may be provided. A wearer may wear the safety assembly 100 as illustrated in FIG. 1, whereby the leg straps 18 would come from the base of the air pack and go between the wearers legs and fasten with connectors 20 and 22 in the locked configuration

The safety assembly 100 is used a different manner in order to save lives. With the current system, if a rescuer grabs the air pack and drags the in-jeopardy firefighter, the air pack will come off. With the safety assembly, the rescuer can grab the top handle 32 as soon as the firefighter is located and drag them to safety because the leg straps 18 will keep the air pack secured to the firefighter.

It should be understood, of course, that the foregoing relates to exemplary embodiments of the invention and that modifications may be made without departing from the spirit and scope of the invention as set forth in the following claims.

1. A safety assembly, comprising:
a back pack extending from an upper portion to a lower portion;
the back pack having an outward surface and an opposing inward surface extending between the upper and lower portions;
a top handle provided by the upper portion via a void that passes from the inward surface through to the outward surface;
a belt extending from the lower portion in opposite directions;
a female connector provided by each distal end of the belt;
two spaced apart leg straps depending from opposing portions of the belt, wherein the two leg straps connect at an attachment point; and
a male connector depending from the attachment point, wherein the male connector removably secures to said female connectors in a locked engagement.

2. The safety assembly of claim 1, wherein the top handle is located adjacent a back neck of a wearer when the safety assembly is worn.

3. The safety assembly of claim 1, wherein the male connector provides two opposing faces, one face for securing to the female connector of each distal end the; and further comprising a bottom handle strap depending from the male connector, the bottom handle strap disposed between the two opposing faces.

4. The safety assembly of claim 3, wherein the bottom handle strap is oriented in an upward orientation when the safety assembly is worn.

5. (canceled)

6. The safety assembly of claim 1, further comprising a GPS locator connected to the safety assembly.

7. A safety assembly, comprising:
a back pack extending from an upper portion to a lower portion;
the back pack having an outward surface and an opposing inward surface extending between the upper and lower portions;
a top handle provided by the upper portion via a void that passes from the inward surface through to the outward surface, wherein the top handle is located adjacent a back neck of a wearer when the safety assembly is worn;
a belt extending from the lower portion in opposite directions;
a female connector provided by each distal end of the belt;
two spaced apart leg straps depending from opposing portions of the belt, wherein the two leg straps connect at an attachment point;
a male connector depending from the attachment point, wherein the male connector is adapted to removably secure to said female connectors in a locked engagement, wherein the male connector provides two faces, one face for securing to the female connector of each distal end the;
a bottom handle strap depending from the male connector, wherein the bottom handle is oriented in an upward orientation when the safety assembly is worn; and
a GPS locator connected to the safety assembly.
